(19) United States
(12) Patent Application Publication
(10) Pub. No.: US 2013/0311136 A1
(43) Pub. Date: Nov. 21, 2013

(54) Rule-Based Sample Verification and Chemical Monitoring Methodology

(71) Applicants: Todd Blonshine, Cary, NC (US); Brian Garrett, Morrisville, NC (US); Peter Cregger, Raleigh, NC (US); Stan Ayers, Cary, NC (US); Adam Wright, Cary, NC (US)

(72) Inventors: Todd Blonshine, Cary, NC (US); Brian Garrett, Morrisville, NC (US); Peter Cregger, Raleigh, NC (US); Stan Ayers, Cary, NC (US); Adam Wright, Cary, NC (US)

(73) Assignee: Mustard Tree Instruments, LLC, Research Triangle Park, NC (US)

(21) Appl. No.: 13/896,717

(22) Filed: May 17, 2013

Related U.S. Application Data
(60) Provisional application No. 61/649,027, filed on May 18, 2012.

(51) Int. Cl. G06F 19/00

(52) U.S. Cl. CPC G06F 19/703
USPC 702/180; 702/189

(57) ABSTRACT

A rule-based verification testing methodology automates the process and allows for field deployment of verification testing instrumentation. A rule-based chemical monitoring methodology automates the verification of a chemical being monitored, as well as the instrument and a sample path, increasing the confidence in the verification process. In both methods, at least Raman spectra of a sample are captured, and compared to a model that is based on reference data. Predetermined, flexible, parameterized rules control the comparison. Additional physical properties, such as color and size, may also be compared (also controlled by predetermined rules).

This application claims priority to U.S. Provisional Patent Application Ser. No. 61/649,027, filed May 18, 2012, titled, “Rules Based Decision Engine,” the disclosure of which is incorporated herein by reference in its entirety.

### FIELD OF INVENTION

The present invention relates generally to analytical instrumentation, and in particular to a rules-based apparatus and method of verifying analytes and analyte monitoring.

### BACKGROUND

Verification of a sample of material—selectively referred to herein as an analyte—is an important analytical process required in a broad variety of industrial and field operations. In many cases, the chemical makeup and/or purity of an analyte must be determined. For example, the purity, or concentration, of precursor chemicals for many industrial and manufacturing operations, such as pharmaceuticals or semiconductor manufacturing, must be verified to ensure that the resulting operations are performed properly. In other cases, the chemical makeup of an unknown sample must be determined, such as the identification of explosive agents or controlled substances in military, law enforcement, and security applications. Verification of an analyte is an important tool for quality control in many manufacturing and refining operations. In addition, verification of other physical properties, such as size, color, elasticity, electrical or thermal conductivity, and the like, may be necessary in some applications.

Conventionally, the verification of discrete samples of analyte is a disruptive and time-consuming process. For example, for chemical analysis, the analyte is typically shipped to a laboratory, where it may be verified by a variety of processes, such as chemical reactions, spectroscopy, microscopy, and the like. While field instruments are known in the art, these usually only provide an indication of the presence or absence of a specific active ingredient; laboratory testing is still required to perform a quantitative analysis, yielding, e.g., the concentration of specific chemicals among bulk or inert ingredients.

Two primary reasons that quantitative analysis of analytes is still limited to a laboratory are the equipment used in the analysis, and the expertise required to perform the testing, both to obtain reliable measurements and to interpret them. High precision analytical equipment is often sensitive to environmental variations, such as ambient light, temperature, vibration, and the like. Operations such as spectroscopy are thus typically confined to a laboratory environment, where such environmental conditions may be carefully controlled. Additionally, quantitative chemical or physical analysis is a complex undertaking, requiring highly trained and experienced technicians to perform accurately and reliably. Furthermore, the interpretation of the data obtained from quantitative analysis is itself a highly complex task, often requiring a background in chemistry, physics, and similar disciplines.

Due to the need to perform analyte verification in a controlled laboratory environment, the complexity and sensitivity of the instrumentation and equipment used in the analysis, and the requirement of advanced technical training by personnel at all stages of the verification process, analyte verification remains disruptive, time-consuming, and expensive. A need exists in the art for the ability to perform analyte verification in an automated manner in the field or on the factory floor, that provides instantaneous, reliable results, and that does not require technically sophisticated personnel to operate.

In some applications, verification of an analyte is crucial to on-going process monitoring. For example, in a chemical manufacturing facility or petroleum refinery, the composition of material flowing through a pipe is monitored continuously or at regular intervals, for quality control and to detect potential changes in the manufacturing/refining process. However, deviations in indicated analyte composition may arise from factors other than actual changes in the analyte composition, such as instrument error, calibration or model drift, or the like.

In these applications, conventional monitoring systems simply raise an alert when the analyte fails to match a reference material in some respect. However, these systems offer no information regarding possible or probable causes of the mismatch. A troubleshooting procedure must be initiated to determine whether the instrument is giving faulty readings—either for going out of calibration or due to obstructions or impurities in a data-gathering path—whether a model on which the monitoring is based is valid, or whether the analyte being monitored has changed in its composition or some other monitored physical property. The investigation may require shutting down a production line or other interruption while trained technicians (who may not be on site) intimately familiar with both the process flow and the instrumentation troubleshoot the anomalous readings. A need exists in the art for the ability to not only perform on-going, automated, analyte verification, but also to intelligently diagnose the health of the instrumentation and models, and to provide information that assists in troubleshooting anomalous analyte verification results.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

As used herein, the term “sample” refers to any material that may be quantitatively analyzed according to embodiments of the present invention. As used herein, an “analyte” is a substance desired to be analyzed or monitored, i.e., its physical properties verified against a known reference material, standard, or model. An analyte is a subset of sample. The term sample additionally includes, e.g., reference materials, calibration standards, sample path elements (as explained herein), and the like—that is, non-analyte substances whose physical properties (e.g., Raman spectra) are measured, and may be compared to reference data, but for which the primary purpose is to gather data, and not to identify or verify the chemical composition or other physical properties thereof.

According to one or more embodiments described and claimed herein, analyte verification against a known reference material is performed in an automated manner, using robust, portable or relocatable equipment. A rule-based testing methodology eliminates the need for technically sophisticated personnel to perform the verification testing. Physical properties of a reference material are measured and stored. Additionally, one or more rules regarding the comparison of measurements of an analyte to the stored reference material measurements are created, associated with the reference material measurements, and stored. Physical properties of an analyte are measured, such as by using robust, compact equipment, in the field or on the factory floor. The measured analyte properties are compared to corresponding, stored properties of the reference material. The comparison is controlled by application of the associated rules, which may specify, e.g., a degree of accuracy, allowable tolerances, and the like. No technical expertise is required to perform the verification testing. By crafting the rules, and adjusting parameters of the rules that control the comparison, the precision of the analysis can be easily adjusted; in many cases, only moderate technical expertise is necessary to adjust the rule parameters.

According to one or more embodiments described and claimed herein, chemical monitoring is performed in an automated manner, using robust, portable or relocatable equipment. A rule-based operating engine monitors analyte composition on an on-going basis, accounting for variations in measurement parameters. The rule-based operating engine also monitors the instrument health and the sample verification path, as well as the calibration state of the instrument, and the models on which the monitoring is based. This approach allows the instrument to automatically debug anomalous readings and troubleshoot problems.

One embodiment relates to a rule-based method of comparing measurements of one or more physical properties of a sample to a model of the sample based on reference data. At least a Raman spectrum of the sample is obtained. A corresponding model of the sample, based on reference data, is retrieved. The Raman spectrum of the sample is compared to the corresponding Raman spectra of the model. One or more pre-determined rules governing the comparison are retrieved, and the pre-determined rules are applied to the comparison.

Another embodiment relates to an analytical instrument operative to perform a rule-based method of comparing measurements of one or more physical properties of a sample to a model of the sample based on reference data. The instrument includes a Raman spectrometer operative to capture a Raman spectrum of the sample. The instrument also includes memory operative to store a model based on reference data comprising Raman spectra of a reference material, and one or more pre-determined rules controlling comparison of the captured sample Raman spectra to the model. The instrument further includes a controller. The controller is operative to control the Raman spectrometer; compare the captured Raman spectrum of the sample to the model; apply one or more pre-determined rules to the comparison; and determine that the sample matches the model only if all applicable pre-determined rules are satisfied.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a flow diagram of a rule-based verification testing methodology.

FIG. 2 depicts a representative Raman spectrum.

FIG. 3 depicts the application of rule parameters to a Raman spectrum.

FIG. 4 depicts the operation of rules excluding zones of a Raman spectrum.

FIG. 5 depicts a color coordinated cube.

FIG. 6 depicts a representative color coordinate quantize value histogram.

FIG. 7 depicts a representative shape determination image.

FIG. 8 is a functional block diagram of an analytical instrument useful for analyte verification.

FIG. 9 is a flow diagram of a method of process control.

FIG. 10 is a functional block diagram of an analytical instrument useful for chemical monitoring.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Analyte Verification

As described above, the need for accurate, fast, easily controlled, on-site or field verification testing of an analyte against a reference material exists in a broad array of industries and applications. The rule-based testing methodology described herein may be advantageously applied to many of them. To provide an enabling disclosure of the invention to those of skill in the art, a detailed explanation of the rule-based verification testing methodology is provided as applied to three specific physical property measurements. These examples demonstrate how the same rule-based verification testing methodology may be applied to measurement and analysis of widely divergent physical properties. Given these representative examples, those of skill in the art may readily extend the rule-based verification testing methodology described herein to the measurement and testing of many other physical properties. Nothing herein should be considered a limitation of embodiments of the present invention to the specific properties measured, or even the specific parameters disclosed for these three measured properties.

As one real-world example of the need for fast, accurate, easy to use field verification testing, quality control in pharmaceutical manufacturing may be dramatically improved by the ability to verify not only the presence and concentration of active ingredient in products such as pills, but also the size and shape of the pills. Conventionally, random samples of pills are removed from the manufacturing line, assigned a control number, and shipped off to a laboratory for analysis. If a deficiency in any of a number of physical properties is discovered, the entire production run, or lot, must be isolated for more extensive testing, and may need to be destroyed. Since production and testing are on-going, the time lag between obtaining the analytes and obtaining the laboratory analysis results may mean that significant quantities of product—manufactured after the analytes were removed from the line but before the analysis results were reported—may have to be destroyed.

An analytical instrument that provides on-site, real-time analysis of several physical properties of analytes, such as pills, is the Tri-Test 1000 instrument available from Mustard Tree Instruments of Research Triangle Park, N.C. The Tri-Test 1000 is a self-contained, automated, portable analytical instrument that includes a Raman spectrometer and color camera with image processing capability. The Raman spectrometer provides nondestructive chemical analysis of an analyte. Sophisticated processing of images obtained of the analyte verifies both the shape of the analyte and its color. A flexible, rule-based verification testing methodology allows non-technical personnel to perform the analyte verification testing. The rule parameters may be adjusted by those with some technical expertise, to adjust the precision of the verification testing. An instrument incorporating Raman spectroscopy and optical color and size/shape verification is representative only—providing a convenient example of how the rule-based verification testing methodology of embodiments of the present invention may be applied to the verification of a wide array of unrelated physical properties—and is not limiting. Quality control in the pharmaceutical manufacturing process is a representative example of a real-world application of the rule-based verification testing methodology of embodiments of the present invention, and is not limiting.

Rule-Based Analyte Verification Testing Methodology

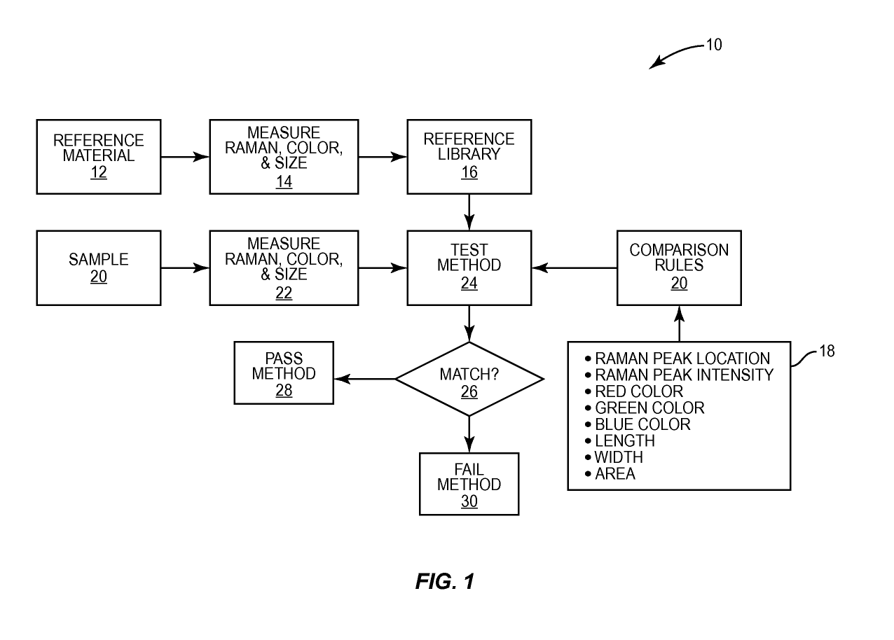

FIG. 1 depicts a high-level flow diagram of the overall rule-based verification testing methodology 10 of embodiments of the present invention. Initially, a reference material, against which analytes are to be verified, is obtained (block 12). At least one physical property of the reference material is measured (block 14). For example, the Raman spectrum (described more fully herein), the color, and the size of the reference material may be measured. The measured properties of the reference material are stored in a reference library (block 16). The reference library may be stored in non-volatile memory in an analytical instrument, or may be stored in an external database, accessible via a wired or wireless connection or network.

One or more rules governing comparisons of measured analyte properties to corresponding stored properties of the reference material are also generated and stored (block 18). As described herein, the rules provide a flexible way to vary the precision of matching measured analyte properties to those of the reference material. A large number of rules may be defined, with default parameters, and stored in a rules database 18.

In a verification operation, an analyte is obtained (block 20). At least one physical property of the analyte is measured (block 22). The physical property measurements correspond to those measurements performed on the reference material. Once measurements of the analyte are obtained, the rule-based verification testing methodology is applied (block 24). In this method, measurements from the analyte are compared to stored measurements of the reference material. The results of these comparisons are interpreted according to selected, predetermined rules (block 20) regarding each measurement. The rules may include parameters that specify, e.g., tolerances, or how closely the measurements must be to determine that the analyte matches the reference material. By adjusting the parameters, the rigor, or precision, of the analyte verification process may be easily adjusted. The rules may be combined in numerous ways. The rules 20 selected for any particular verification test may be assembled from the database 18 of rules.

The application (block 26) of the selected, parameterized, predetermined rules 20 to the comparison of measured analyte properties 22 and stored reference material properties 16 results in the analyte being verified by passing all rules (block 28), or failing verification if at least one rule is not satisfied (block 30). Once the reference material physical property measurements are taken and stored, and appropriate rules crafted and selected (and, if applicable, parameters within the rules determined), the entire rule-based verification testing methodology 10 is automated, and results in a simple go/no-go verification indication. The verification testing may be performed in the field or on the factory floor, by personnel without technical expertise in any of the physical properties being measured. The time to perform the test is essentially the time required to place an analyte in the analytical instrument and perform the physical property measurements; the results are near-instantaneous. This obviates the need for laboratory testing, and dramatically reduces lag time. Accordingly, an analytical instrument implementing the rule-based verification testing methodology 10 enables real-time quality control and other analyte verification applications not possible according to prior art analyte verification methods.

Raman Spectroscopy

Raman spectroscopy is an analytic instrumentation methodology useful in ascertaining and verifying the molecular structures of materials. Raman spectroscopy relies on inelastic scattering, or Raman scattering, of monochromatic light, resulting in an energy shift in a portion of the photons scattered by an analyte. From the shifted energy of the Raman scattered photons, vibrational modes characteristic to a specific molecular structure can be ascertained. This is the basis of using Roman spectroscopy to ascertain the molecular makeup of an analyte. In addition, by analytically assessing the relative intensity of Raman scattered photons, the purity of an analyte can be determined.

Typically, an analyte is illuminated with a laser beam. Light from the illuminated spot is collected by lenses and analyzed. Wavelengths close to the laser line due to elastic Rayleigh scattering are blocked or filtered out, while chosen bands of the collected light are directed onto a detector.

The Raman effect occurs when light impinges upon a molecule and interacts with the electron cloud and the bonds of that molecule. For the spontaneous Raman effect, which is a form of light scattering, a photon excites the molecule from its ground state to a virtual energy state. The energy state is referred to as virtual since it is temporary, and not a discrete (real) energy state. When the molecule relaxes, it emits a photon and it returns to a different rotational or vibrational state. The difference in energy between the original state and this new state leads to a shift in the emitted photon's frequency away from the excitation wavelength.

If the final vibrational state of the molecule is more energetic than the initial state, then the emitted photon will be shifted to a lower frequency in order for the total energy of the system to remain balanced. This shift in frequency is known as a Stokes shift. If the final vibrational state is less energetic than the initial state, then the emitted photon will be shifted to a higher frequency, which is known as an Anti-Stokes shift. Raman scattering is an example of inelastic scattering because of the energy transfer between the photons and the molecules during their interaction.

The pattern of shifted frequencies is determined by the rotational and vibrational states of the analyte, which are characteristic of the molecules. The chemical makeup of an analyte may thus be determined by quantitative analysis of the Raman scattering.

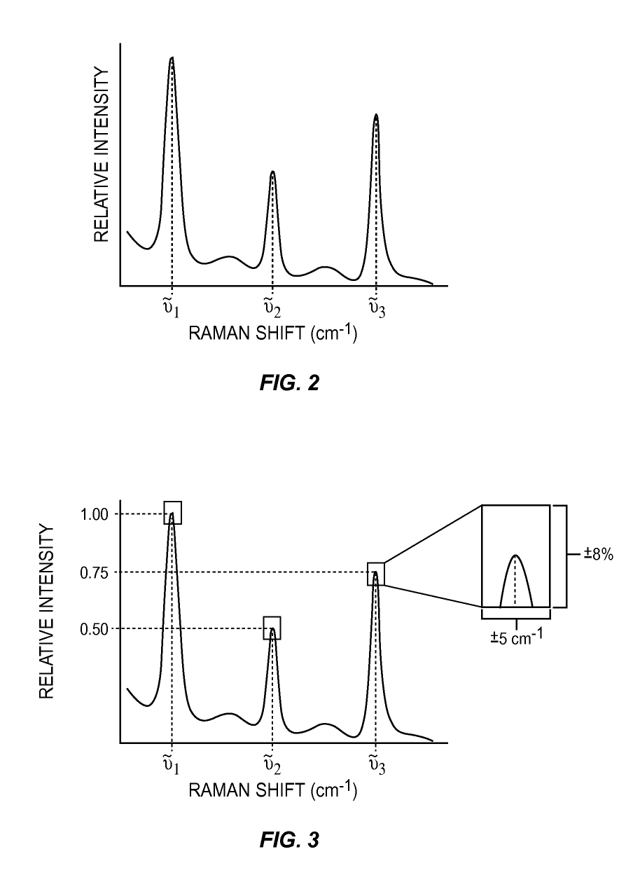

FIG. 2 depicts a representative Raman spectrum. Raman shifts are typically described as wavenumbers, which have units of inverse length. A wavenumber relates to frequency shift by

$$Δ w = ( \frac{1}{{λ}_{0}} - \frac{1}{{λ}_{1}} )$$

where

w is the wavenumber;

λ₀ is the wavelength of the excitation laser beam 14; and

λ₁ is the wavelength of the Raman scattered photon.

In particular, FIG. 2 depicts a Raman spectrum for a hypothetical material. The spectrum features three distinct peaks, having different relative intensities, located at wavenumbers \hat{ν}₁, \hat{ν}₂, and \hat{ν}₃. These peak locations and relative intensities may be characteristic of the chemical makeup of a homogenous analyte. Alternatively, the analyte may comprise a mixture, with one or more of the peak locations (and possibly also the relative intensity) being characteristic of one chemical, and one or more other peak locations being characteristic of a different chemical. In some cases, the relative concentration of two or more chemicals in a mixture may also be determined by comparison of the relative intensities. Thus, a Raman spectroscopic analysis may not only verify a particular chemical or mixture of chemicals, but also quantify the relative proportions of the chemicals. In this manner, the concentration, or purity, of an active ingredient in a base or stock of inert ingredients may be determined. In general, both Raman peak location and the relative intensity of Raman peaks are physical properties of an analyte that may be measured, compared to corresponding, stored Raman peaks of a reference material, and one or more rules applied to the comparison to verify the chemical makeup of the analyte against the reference material.

In an embodiment applicable to the spectrum of FIG. 2, a rule for the comparison of Raman peak locations may comprise “Compare the peak location of the top 3 Raman peaks.” According to this rule, the 3 highest intensity peaks in the Raman spectrum of an analyte would be identified, and their location (e.g., in wavenumber, such as cm⁻¹) compared to a corresponding stored Raman spectrum of the reference material.

In one embodiment, a parameter may be utilized within the rule. Parameters increase the flexibility of rules, and decrease the proliferation of rules by allowing a single rule to be varied by changing its parameters. For example, a rule applicable to the spectrum of FIG. 2 may be “Compare the peak location of the top n Raman peaks,” where n is an integer greater than zero. When verifying an analyte that has a large number of distinct peaks, more accurate verification may be obtained by increasing the value of n, which requires that numerous peak locations of the analyte Raman spectrum match those of the reference material. Conversely, the verification rate when testing numerous analytes may be increased by reducing the value of n, thus requiring fewer peak locations of the analyte Raman spectrum to match those of the reference material. When verifying analytes with a large number of distinct, characteristic peaks, requiring fewer than all of the peak locations to match those of the reference material may still provide adequate verification confidence, but reduce the number of verification failures due to noise, quantization errors, and the like.

In one embodiment, the verification failure rate may be reduced without a concomitant lack of confidence in the makeup of the analyte, by requiring the identification of n distinct peak locations, but only requiring m of those peaks to match the reference material, where m≦n. Such a rule may comprise, “Compare the peak location of the top n Raman peaks, and at least m must match,” where m≦n. Note that where m=n, this rule is the same as “Compare the peak location of n peaks.”

In addition to the location of Raman peaks, the relative intensity of peaks is a characteristic property of materials. For blends and mixtures, the relative intensity of peaks may indicate the ratio of the combined materials. FIG. 3 depicts the same three Raman peaks as FIG. 2, with the relative intensities quantified. The highest intensity peak, \hat{ν}₁, is set at 100%. The other two peaks are quantified relative to \hat{σ}₁, with the peak at \hat{ν}₂ being 50% of the peak at \hat{ν}₁, and the peak at \hat{ν}₃ being 75% of the peak at \hat{ν}₁. Rules may be applied to the comparison of relative intensities of Raman peaks, similarly to the peak locations. For example, one rule may comprise, “Compare the relative intensities of the top n Raman peaks,” where n is an integer greater than zero. Another applicable rule may comprise, “Compare the relative intensities of the top n Raman peaks, and at least m must match,” where m≦n. These rules may be combined with other rules. Note, however, that a matching peak location is inherent in a comparison of relative intensities; hence, the rule count may be reduced when comparing Raman peak relative intensities by omitting the corresponding peak location rules.

To accommodate noise, small calibration errors, and other error sources such as fluctuations in ambient temperature, pressure, and/or relative humidity, and the like, predetermined tolerances in both peak location (in cm⁻¹) and relative intensity (in %) may be applied. For example, as depicted in FIG. 3, an analyte Raman peak may be determined to match a corresponding reference material Raman peak if its peak location is within +/−5 cm⁻¹ of that of the reference material, and its relative intensity is within +/−8%. The specification of tolerances in peak location and relative intensity effectively define a rectangle around each measured analyte Raman peak. If a corresponding reference material Raman peak falls within the rectangle, the peaks are deemed to match for the purpose of applying the relevant comparison rules. In one embodiment, one or both of the peak location and relative intensity tolerances are “global” parameters, in that once they are set, they apply to all rules governing the comparison of Raman spectra. In another embodiment, one or more (up to all) rules may include explicit peak location and/or relative intensity tolerances, which override any such global tolerances for the purpose of application of that rule. Although described herein with respect to Raman spectra measurements, the concepts of parameterized rules and global/rule-specific comparison tolerances are applicable in applying the inventive rule-based verification methodology to any measured physical properties.

Another type of Raman spectrum rule disregards peaks below a specified threshold for relative intensity. This allows for the rejection of signals which may be attributed to noise or the like, and are not true Raman peaks. Although this would typically be a global threshold, it could be specified per-rule, or could be overridden by a parameter in individual rules.

In one embodiment, Raman peak location and/or relative intensity within only a subset of a measured analyte Raman spectrum may be compared to a reference material. This is useful, for example, when one or more key peaks to be verified are characteristically smaller than many or most peaks in the spectrum. As another example, most of the Raman spectra of an analyte comprising a mixture may match that of a reference mixture, but it is desired to specifically verify a chemical of relatively low concentration, the Raman peaks of which may have a lower relative intensity than most of the Raman spectrum. In these cases, a rule may exclude ranges of the Raman spectrum. Such a range exclusion rule may be combined with a rule regarding the comparison of Raman peak locations or relative intensities.

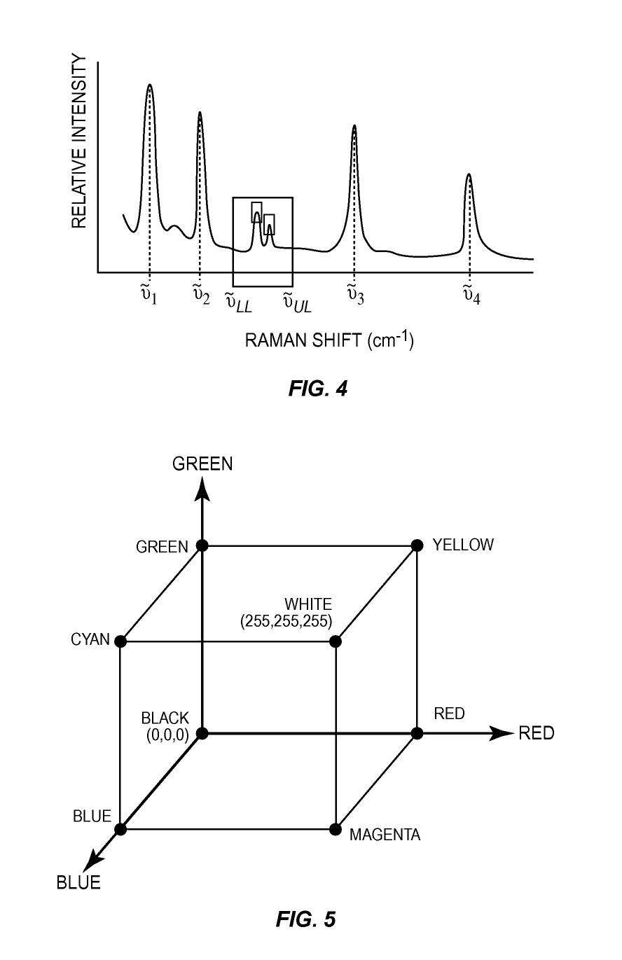

FIG. 4 depicts a representative analyte Raman spectrum, for which it is desired to verify the presence of the two smaller peaks, in the range between a lower limit \hat{ν}_{LL} and an upper limit \hat{ν}_{UL}. A rule to accomplish this may comprise, “Omit cm⁻¹ range from 500 to \hat{ν}_{LL} and from \hat{ν}_{HL} to 1800; Compare the relative intensities of the top 2 Raman peaks, and at least 2 must match.” For a complete verification, the Raman peaks outside the range of interest may additionally be verified by applying the following rule, “Compare the peak location of the top 4 Raman peaks, and at least 4 must match.” This is also an example of how rules may easily be combined to create powerful, customized verification regimens.

Color Verification

In one embodiment a physical property of an analyte that is measured and compared to a corresponding property of a reference material is color. An analytical instrument includes a color image capture device and image processing circuits. The image capture device may comprise, for example, a Charge Coupled Device (CCD) array, a CMOS sensor, or other appropriate image sensor with necessary circuits. An image of the analyte is captured and analyzed to measure its color. In one embodiment, prior to the color analysis, image processing circuits perform edge detection to isolate the portion of the captured image that represents the analyte. Such image processing circuits may, for example, comprise hardware circuits; programmable logic circuits together with appropriate firmware; a stored-program processing circuit such as a microprocessor or Digital Signal Processor (DSP), together with appropriate software; or any combination thereof.

In one embodiment, the image processing circuit represents the image with three color coordinates. In one embodiment, the color coordinates are Red (R), Green (G), and Blue (B), although other color coordinates are possible (e.g., CMY, HSV, YUV, YCbCr, etc.). The RGB color coordinates conceptually form a color cube, as depicted in FIG. 5. Each of the R, G, and B axes comprises a plurality of quantized coordinate values. In one embodiment, each R, G, B axis includes 256 quantized coordinate values, ranging from 0:255. The origin at RGB:000 represents black, and the diagonal at RGB:255,255,255 represents white. All other colors have RGB coordinates between these two corner conditions, and each color may be considered as a point in the space within the RGB color coordinate cube. There are over 16 million quantized colors within the RGB cube.

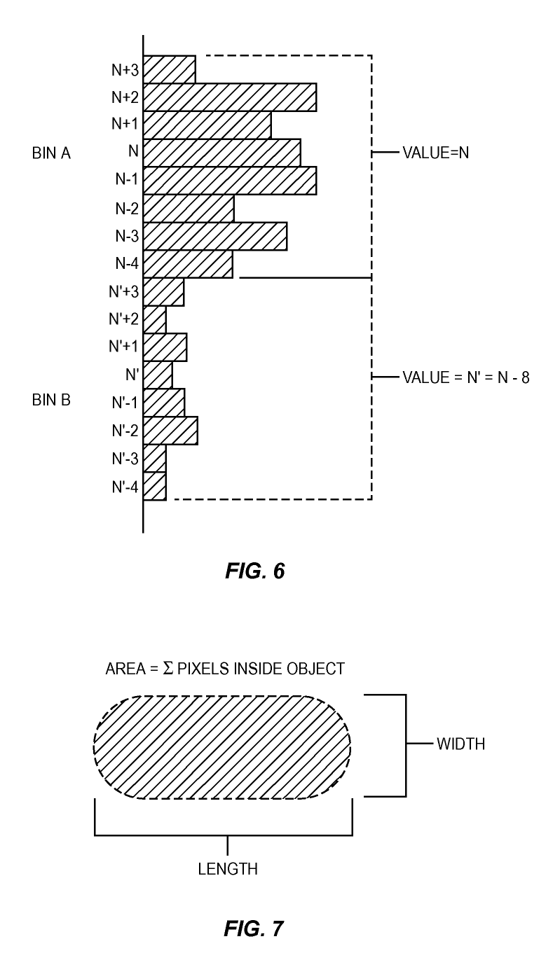

In one embodiment, because of the very large number of possible quantized colors, a two-level thresholding approach is taken in comparing a measured analyte color to the stored reference material color. First, pixel counts are collected for each quantized color coordinate value, forming a long histogram along each color coordinate axis. These three histograms are divided into a plurality of smaller histograms, or “bins,” as depicted in FIG. 6. In one embodiment, each bin includes eight quantized color coordinate values, yielding 32 bins per color coordinate axis. The intensity of a bin is the total of all pixel counts within the bin—that is, the number of times, over the area of the image, that a pixel assumed a quantized coordinate value falling within the bin. The intensity of each bin is associated with the value of one quantized color coordinate value in the bin. In one embodiment, the intensity of each bin is associated with the value of the center quantized color coordinate value. As used herein, the “center” value is the center value for a bin including an odd number of values, and is one of the two center values for a bin including an even number of values. In the embodiment described, this process result in 32 intensity values per color coordinate axis, each associated with a quantized color coordinate value separated by 8 units from the next intensity value. The collection of pixel values into small histograms is a first level of thresholding.

The quantized color coordinate value associated with the highest intensity bin in each color coordinate axis for the measured analyte is then compared to the value, for the corresponding axis, associated with the highest intensity bin for the reference material. In one embodiment, a second level of thresholding occurs in the rules comparing analyte color values to those of the reference material. For example, the rules may comprise, “Difference in R-coordinates≦n,” “Difference in G-coordinates≦n,” and “Difference in B-coordinates≦n,” where n is an integral multiple of the width of a bin (8, in the embodiment described above). These rules will indicate a color match if the highest intensity values on each of the R, G, and B axes for an analyte were within 3 bins of their respective values for the reference material. Larger values of n will indicate a match for more divergent colors. The values of n may differ for each axis.

The grouping of pixel counts into a plurality of small histograms along each color coordinate axis is representative of one method of image comparison, but is not a limitation of the present invention. Many image color comparison algorithms, of varying accuracy and robustness, are known in the art, and may be readily adapted to the task of rule-based analyte verification by those of skill in the art, given the teachings of the present disclosure.

Size Verification

In many manufacturing operations, verifying the physical size and/or shape of an analyte against a reference material is important. In one embodiment, a physical property of an analyte that is measured and compared to a corresponding property of a reference material is size. An analytical instrument includes an image capture device and image processing circuits, which may be as described above. Note, however, that color image capture is not required. Indeed, the size measurement device may comprise an infrared image sensor, or other form of image sensor.

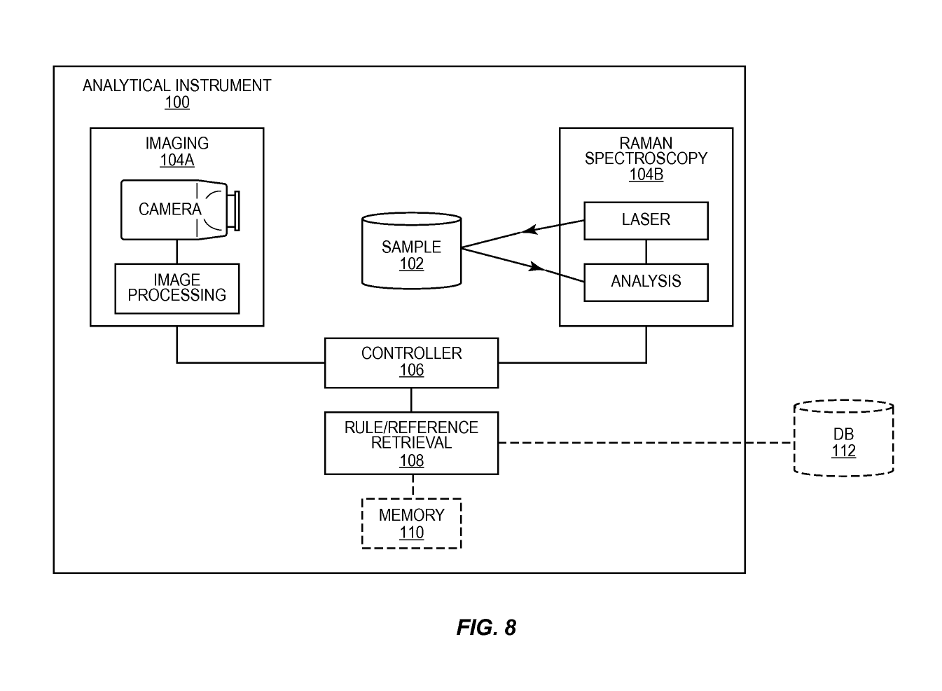

An image of the analyte is captured and analyzed to measure size parameters. Various image processing operations, such as edge detection, rotation, and the like may be performed, as known in the art, to align the image of the analyte in preparation for size analysis. The image, a representative example of which is depicted in FIG. 7, is then analyzed along several parameters to verify its size. The particular, specific such analyses may depend on the nature and shape of the analyte. As one representative and non-limiting example, when the analyte is a simple shape such as a pharmaceutical pill, the parameters measured may include the length, width, and area. In this example, the length is the number of pixels of the analyte image in the longest dimension. The width is the number of pixels of the analyte image in the shortest dimension. The area is the summation of pixels within the detected boundary of the analyte image.

In one embodiment, rules controlling the size comparison specify a threshold for each such dimension. The threshold may be conveniently expressed as pixels. However, where the resolution of the image is known, these may easily be converted between pixels and conventional units of length, such as inches or centimeters. For example, in one embodiment, a size measuring device yields an image at a resolution of 16 pixels per millimeter, or 0.0625 mm/pixel.

Representative rules governing the comparison of analyte size parameters with the corresponding size parameters of a reference material may comprise, “Difference in Length≦l pixels,” “Difference in Width≦w pixels,” and “Difference in Area≦a pixels.” In one embodiment, l=w=16, and a=1200. These parameter values correspond to a linear tolerance of 1 mm, and an area tolerance of ˜4.5 mm².

Analytical Instrumentation for Analyte Verification

An apparatus operative to implement the rule-based verification testing methodology 10 of embodiments of the present invention is depicted in FIG. 8. The analytical instrument 100 includes an analyte area 102, one or more measurement devices 104, a controller 106, and a rules and reference material retrieval circuit 108 connected to one or both of internal memory 100 and an external database 112.

Analyte material is placed in an appropriately sized area 102 for analysis. In one embodiment, a measuring device 104 comprises an imaging system 104A, which may include, for example, an image capture circuit such as a camera and image processing circuits. The imaging system 104A may be operative, for example, in performing color and size verification. In one embodiment, a measuring device 104 comprises a Raman spectroscopy device 104B, which may include, for example, a laser source to illuminate the target with an excitation laser beam, and an analysis circuit to analyze the Stokes and anti-Stokes Raman-shifted optical return. The imaging system 104B may be operative, for example, to performing chemical analysis and verification.

A controller 106 is operative to control measurement devices 104 to obtain a measured physical property of the analyte; compare the measured property of the analyte to a corresponding property of the reference material; apply one or more pre-determined rules to the comparison; and determine that the analyte matches the reference material only if all applicable pre-determined rules are satisfied. The controller 106 may comprise any sequential state machine operative to execute machine instructions stored as machine-readable computer programs, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

The controller 106 retrieves reference material measurements, for comparison with measurements of the analyte, and rules that govern the comparisons, from a rules and reference material retrieval circuit 108. In one embodiment, the retrieval circuit 108 comprises an interface to non-volatile memory 110. The memory 110 may comprise any non-transient, non-volatile, machine-readable media known in the art or that may be developed, including but not limited to magnetic media (e.g., floppy disc, hard disc drive, etc.), optical media (e.g., CD-ROM, DVD-ROM, etc.), solid state media (e.g., ROM, PROM, EPROM, Flash memory, solid state disc, etc.), and the like. In one embodiment, the rules and reference material retrieval circuit 108 comprises an interface to an external database 112. In this embodiment, the retrieval circuit 108 may comprise an interface to a wired or wireless direct connection to a server or similar database 112, or may comprise an interface to a wired or wireless network, with the database accessed via a server or the like on the network. In either case, the rules and reference material retrieval circuit 108 is operative to retrieve previously measured and stored physical properties of a reference material against which the analyte is to be verified. The retrieval circuit 108 is also operative to retrieve all applicable rules governing the comparison of analyte properties to reference material properties, as well as all parameters of such rules, global thresholds, and the like.

Chemical Monitoring

One real-world example of the need for on-going process monitoring with intelligent fault diagnosis and self-testing is the monitoring of chemicals, such as petroleum products flowing through a pipe in a refinery. The chemical makeup of the product must be continually monitored, to ensure the integrity of the refining process and consistency of the output. Since a typical industrial petroleum refinery is a harsh environment, it is advantageous that the analytical instrumentation used in the monitoring be able to not only withstand the environment, but to diagnose possible/probable causes of analyte verification results that are not within the defined specifications.

An analytical instrument that provides on-site, in-situ, real-time, on-going analysis and monitoring of a continuous stream of analyte is the Verifier Process System VPS-1000 instrument available from Mustard Tree Instruments of Research Triangle Park, N.C. The VPS-1000 is an automatic, non-contact, non-destructive, real time chemical monitoring and control instrument for liquids, mixtures, colloidal and solid flowing systems. The VPS-1000 includes a Raman spectrometer with adaptive, free-space optics to optimize the Raman collection point, e.g., through a sight glass and into the mass of chemical flowing in a pipe. That is, the VPS-1000 emits an excitation laser beam. The focal point of the return optics, also known as the Collection Point (CP), from which the Raman spectrum is extracted, is variable by means of a unique, adjustable focus system. This allows the VPS-1000 to be located, for example external to a pipe carrying analyte chemical, adjacent to a sight glass formed in the pipe. The excitation laser is directed through the sight glass into the interior of the pipe, and hence into the flowing chemical. The adaptive, free-space optics allows the CP to be positioned anywhere within a range of distances into the pipe interior.

Rule-Based Chemical Monitoring Methodology

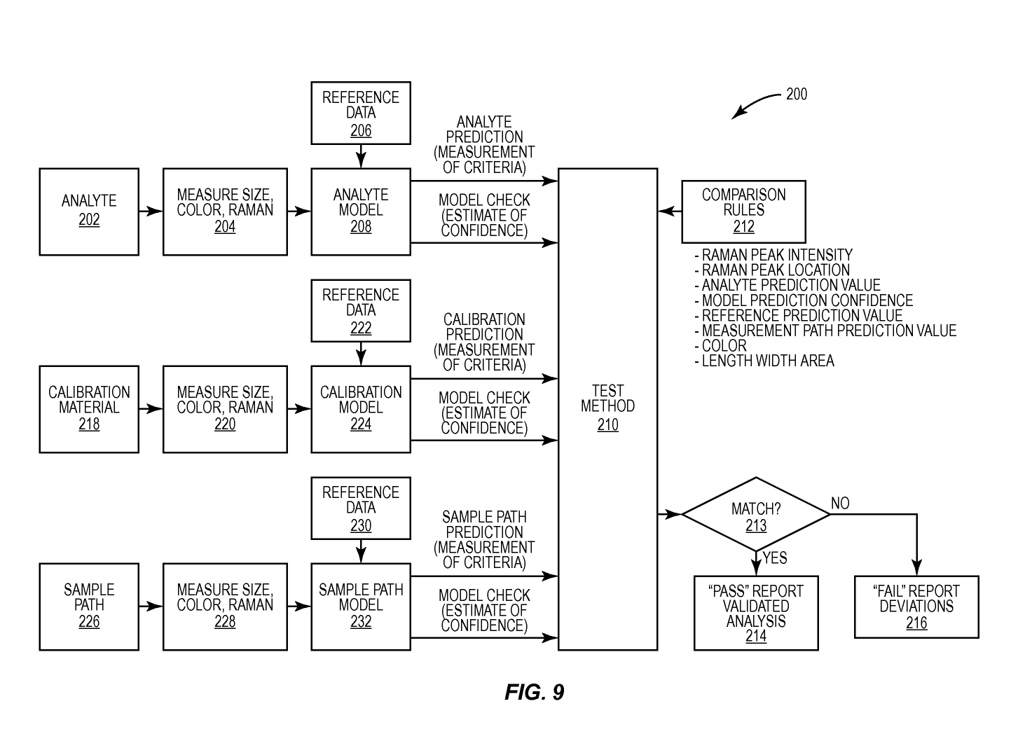

FIG. 9 depicts a high-level flow diagram of the overall rule-based chemical monitoring methodology 100 of embodiments of the present invention. An analyte 202 is measured 204 to obtain quantitative measurements of one or more physical properties, such as Raman spectrum. Reference data 206 comprise corresponding measurements of a reference material against which measurements of the analyte 202 are compared. The reference data 206 may include numerous measurements of the target chemical, taken under varying environmental conditions, flow rates, and the like. The analyte measurements 204 are compared against an analyte model 208.

The analyte model 208 predicts, e.g. the spectral characteristics of the analyte under various conditions. Using sophisticated statistical analysis and regression software, the analyte model 208 generates an analyte prediction and additionally a check of the analyte model itself. A rule-based monitoring test method 210 applies one or more predetermined rules 212 to the comparison of analyte measurements 204 against the analyte model 208 built from the reference data 206. If the rule-driven comparisons pass (block 212), the analyte passes and a validated analysis is reported (block 214). If at least one rule is not satisfied (block 212), the analyte fails validation, and the specific deviations are reported (block 216).

This portion of the rule-based chemical monitoring method 100 is a superset of the rule-based analyte verification testing methodology 10 of FIG. 1. In the method 10, the analyte model 208 comprises simply one or more prior measurements of a reference material against which the analyte is verified. In the chemical monitoring method 100, the models 208, 224, 232 are pre-established mathematical regression procedures which derive single-valued scores, such as concentration of an analyte, from a complex data set, such as Raman spectra. In one embodiment, the regression is a Partial Least Squares regression. In one embodiment, the score returned by the model for a particular observation is generated by transforming the spectral data into latent variables. The magnitudes of the latent variables are then applied to a covariance matrix which yields the model result. The covariance matrix may be built by taking Raman spectra of known samples, and then analyzing the samples with a trusted, alternate analytical method, such as chromatography or mass spectroscopy. This alternate analysis is typically not part of the analytical instrument deployed in the field. The measurements taken to establish the covariance matrix are known in the art as a “training set,” and are part of the reference data 206, 222, 230. In some embodiments, the models 208, 224, 232 additionally include mathematical checks of the models themselves, yielding confidence estimates which may be used by the comparison rules 212 to further validate the test results.

In addition to analyte verification, the overall rule-based chemical monitoring method 100 further monitors its own calibration state, and the data path by which measurement are obtained. These are potential sources of erroneous analyte verification errors; verifying these parameters increases the confidence of the methodology 100 by eliminating potential false validation failures.

In a calibration procedure, a sample comprising calibration material 218 is measured 220 to obtain quantitative measurements of one or more physical properties, such as Raman spectrum. A calibration standard may comprise, for example, Sapphire or YAG (Yttrium Aluminum Garnet), or a stable polymer such as PETE. Reference data 222 comprise corresponding measurements of the calibration material obtained earlier. The reference data 222 may include numerous measurements of the calibration material taken under varying environmental conditions. The calibration material measurements 220 are compared against a calibration model 224. The calibration model 224 predicts, e.g. the spectral characteristics of the calibration material under various conditions. Using sophisticated statistical analysis and regression software, the calibration model 224 generates a calibration prediction and additionally a check of the calibration model itself. The rule-based test method 210 applies one or more predetermined rules 212 to the comparison of calibration measurements 220 against the calibration model 224 built from the reference data 222. If the rule-driven comparisons pass (block 212), the calibration process passes and a validated analysis is reported (block 214). The calibration results may be added to the reference data 222. If at least one rule is not satisfied (block 212), the calibration procedure fails, and the specific deviations are reported (block 216).

The instrument failing calibration will raise alarms that require diagnostics by technicians. Calibrations may be required periodically, following a predetermined number of analyte verification procedures, or prior to every analyte verification, depending on the application. Note that, even for analyte verification procedures that do not require a concomitant calibration procedure, the calibration state of the instrument (i.e., that its last-performed calibration spectrum matches a reference spectrum) may be checked by including the criterion in a rule.

Even a properly calibrated instrument may yield erroneous analyte monitoring results if a data path is occluded, obscured, or otherwise subjected to interference. For example, in the case of an optical measurement, such as that performed by the VPS-1000, the sight glass in a pipe, through which the excitation laser and return optics pass for Raman spectroscopy, may become occluded with particulates. This would attenuate, and potentially refract or otherwise alter, the optical path, resulting in skewed Raman spectra, even when the chemical properties of the analyte are unchanged. Such a mismatch in analyte verification would, in prior art instruments, raise a false alarm, possibly shutting down production under the belief that the chemical composition of the product is incorrect. To avoid such false alarms, and hence increase the confidence in the monitoring process 100, a sample path analysis is periodically performed.

In a sample path analysis procedure, elements of the sample path 226, such as the glass in a sight window, are measured 228 to obtain quantitative measurements of one or more physical properties, such as Raman spectrum. Reference data 230 comprise corresponding measurements of the sample path obtained earlier. The reference data 230 may include numerous measurements of the sample path taken under varying environmental conditions. The sample path measurements 228 are compared against a sample path model 232. The sample path model 232 predicts, e.g. the spectral characteristics of the sample path under various conditions. Using sophisticated statistical analysis and regression software, the sample path model 232 generates a sample path prediction and additionally a check of the sample path model itself. The rule-based test method 210 applies one or more predetermined rules 212 to the comparison of sample path measurements 228 against the sample path model 232 built from the reference data 230. If the rule-driven comparisons pass (block 212), the sample path validation passes and a validated analysis is reported (block 214). The sample path results may be added to the reference data 230. If at least one rule is not satisfied (block 212), the sample path validation procedure fails, and the specific deviations are reported (block 216). The instrument failing the sample path validation will raise alarms that require remedial action, such as inspection and cleaning of the sample path, by technicians.

All of the tests 210, including analyte monitoring 204, calibration 220, and sample path validation 228, the comparison of measurements against reference data 206, 222, 230 are controlled by predetermined rules 212. As discussed above with respect to the rule-based analyte validation method 10, the rules may include parameters, and may be subject to global thresholds. In particular, rule governing comparison of Raman spectra may include peak location and relative intensity rules, may omit ranges, and may specify a global lower intensity threshold. Additionally, the comparison rules 212 may include rules related to integrity checks of the models 208, 224, 232. These may be combined with rules governing the quantative measurement comparisons.

Analytical Instrumentation for Chemical Monitoring

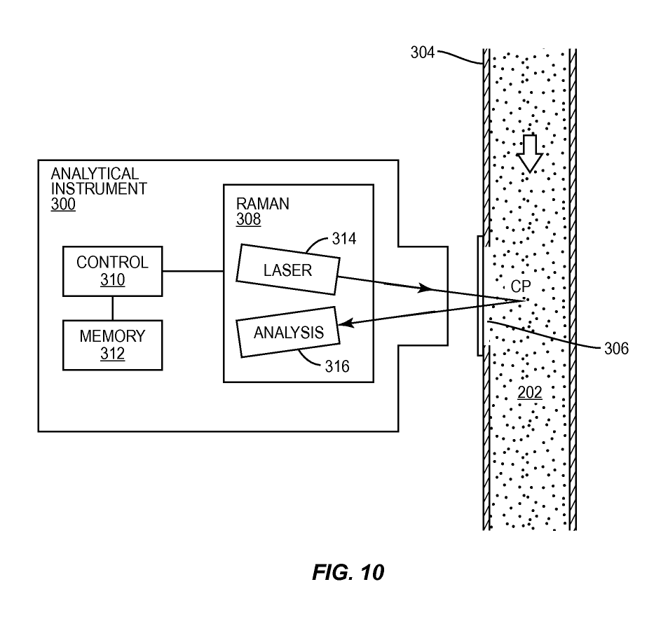

An apparatus 300 operative to implement the rule-based chemical monitoring methodology 100 of embodiments of the present invention is depicted in FIG. 10. The analytical instrument 300 is depicted in a typical application: monitoring the chemical composition of an analyte 202 flowing in a pipe 304. A sight glass 306 in the pipe 304 provides an optical path for the instrument 300. The analytical instrument 300 includes a Raman spectrometer 308, a controller 310, and memory 312.

The Raman spectrometer 308 includes a laser source 314 and an analysis circuit 316, as well as concomitant optical elements (not shown). Under the control of the controller 310, the laser 314 illuminates the analyte chemical within the pipe 304, through the sight glass 306. Adaptive free-space optics in the Raman spectrometer 308 focus the Collection Point (CP) of the Raman return at a desired point within the analyte chemical in the pipe 304. The return optical signal is received and analyzed by the analysis circuit 316.

The controller 310, which may comprise circuits as described above with respect to the analytical instrument 100 of FIG. 8, is operative to capture Raman spectra of the chemical analyte continuously, or at predetermined intervals. The controller 310 retrieves from memory 312 an analyte model 208 based on reference data 206, also stored in memory 312 (see FIG. 9). The controller further retrieves from memory 312 one or more predetermined rules controlling the comparison of the analyte Raman spectrum to the analyte model 208.

The memory 312, which may comprise circuits as described above with respect to the analytical instrument 100 of FIG. 8, is operative to store reference data 206, 222, 230; analyte model 208; calibration model 224; sample path model 232; and predetermined comparison rules 212.

Embodiments of the present invention present numerous advantages over prior art sample verification methods. An analytical instrument 100 operative to perform the methods described herein may be deployed in the field or on the factory floor. Its automated operation avoids the need to collect analytes and send them off to a distant lab for verification analysis. The rule-based verification methodology 10 implemented by the analytical instrument 100 largely automates the analyte verification process, and may be performed by personnel without extensive technical training or expertise. The rule-based verification methodology 10 is highly flexible, and may be easily modified (e.g., combining rules, adjusting rule parameters, adjusting global thresholds, and the like) to dynamically adjust the accuracy—and hence failure rate—of the verification process. The near-real-time results, ease of operation, flexibility, and accuracy of embodiments of the present invention enable a wide range of quality control and field identification procedures not possible using prior art analyte verification methods and equipment.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A rule-based method of comparing measurements of one or more physical properties of a sample to a model of the sample based on reference data, comprising:
obtaining at least a Raman spectrum of the sample;
retrieving a corresponding model of the sample based on reference data;
comparing the Raman spectrum of the sample to the corresponding Raman spectra of the model;
retrieving one or more pre-determined rules governing the comparison;
applying the pre-determined rules to the comparison; and
determining that the sample matches the reference material only if all applicable pre-determined rules are satisfied.

2. The method of claim 1 wherein a pre-determined rule includes one or more adjustable parameters.

3. The method of claim 1 wherein the sample is an analyte to be verified against a reference material, and wherein the model comprises one or more prior measurements of the reference material.

4. The method of claim 3 further comprising:
obtaining at least a Raman spectra of the reference material;
storing the measured Raman spectra of the reference material as reference data;
generating at least one rule relating a measured the measured Raman spectra of an analyte to the Raman spectra of the reference material; and
storing the rule in a library.

5. The method of claim 1 wherein the sample is calibration material, and wherein the model comprises one or more prior measurements of the calibration material.

6. The method of claim 1 wherein the sample is an element in the path from the sample to a measuring instrument, and wherein the model comprises one or more prior measurements of the sample path.

7. The method of claim 1 wherein comparing the Raman spectrum of the sample to the corresponding Raman spectra of the model comprises comparing the location of one or more Raman peaks.

8. The method of claim 7 wherein comparing the Raman spectrum of the sample to the corresponding Raman spectra of the model comprises comparing the relative intensity of one or more Raman peaks.

9. The method of claim 7 wherein a rule comprises comparing the location of the largest n Raman peaks in the measured sample spectrum with corresponding peak locations in the model, where n is an integer greater than zero.

10. The method of claim 9 wherein the rule further specifies that the location of at least m of the n largest Raman peaks must match, where m≦n.

11. The method of claim 8 wherein a measured sample Raman peak matches a corresponding model peak if the location of the peak matches to within a first predetermined tolerance and the intensity of the peak matches to within a second predetermined tolerance.

12. The method of claim 7 wherein the rule omits one or more defined ranges of the Raman spectrum from the comparison.

13. The method of claim 7 wherein the rule specifies a predetermined lower intensity threshold, below which no comparisons are performed.

14. The method of claim 1 wherein the sample is an analyte to be verified against a reference material, and wherein the model comprises one or more prior measurements of the reference material, and further comprising:
capturing an image of the analyte;
retrieving a corresponding image of the reference material; and
comparing the image of the analyte to the corresponding image of the reference material;

15. The method of claim 14 wherein capturing an image of the analyte comprise capturing a color image of the analyte and extracting, for each pixel in the image, at least three color coordinate values.

16. The method of claim 15 wherein the three color coordinates are red, green, and blue.

17. The method of claim 15, further comprising, for each color coordinate:
generating a plurality of histograms of pixel counts, each histogram spanning a predetermined number of quantized color coordinate values;
totaling the number of pixel counts within each histogram; and
representing each histogram by a single quantized color coordinate value within the histogram.

18. The method of claim 17 wherein the single quantized color coordinate value within the histogram is the center quantized color coordinate value.

19. The method of claim 17 wherein a rule comprises determining an analyte color matches a reference material color if, for each color coordinate, the histogram of the analyte color having the largest total number of pixel counts is with a predetermined number of histograms of the reference material having the largest total number of pixel counts.

20. The method of claim 14 further comprising performing edge detection on the captured image to determine its shape.

21. The method of claim 20 further comprising determining a length as the longest dimension of the detected sample shape in pixels, and comparing the analyte length to a length of the reference material.

22. The method of claim 21 wherein a rule comprises determining the length of the analyte shape matches the length of the reference material if difference in the two lengths is not greater than l pixels, where l is a non-negative integer.

23. The method of claim 20 further comprising determining a width as the shortest dimension of the detected sample shape in pixels, and comparing the analyte width to a width of the reference material.

24. The method of claim 23 wherein a rule comprises determining the width of the analyte shape matches the width of the reference material if difference in the two widths is not greater than w pixels, where w is a non-negative integer.

25. The method of claim 20 further comprising computing an area of the detected sample shape as a summation of the pixels inside the detected sample shape.

26. The method of claim 25 wherein a rule comprises determining the area of the analyte shape matches the area of the reference material if difference in the two areas is not greater than a pixels, where a is a non-negative integer.

27. An analytical instrument operative to perform a rule-based method of comparing measurements of one or more physical properties of a sample to a model of the sample based on reference data, the instrument comprising:
a Raman spectrometer operative to capture a Raman spectrum of the sample;
memory operative to store a model based on reference data comprising Raman spectra of a reference material, and one or more pre-determined rules controlling comparison of the captured sample Raman spectra to the model;
a controller operative to:
control the Raman spectrometer;
compare the captured Raman spectrum of the sample to the model;
apply one or more pre-determined rules to the comparison; and
determine that the sample matches the model only if all applicable pre-determined rules are satisfied.

28. The instrument of claim 27 further comprising an image capture and processing device.
